(19) United States
(12) Patent Application Publication
(10) Pub. No.: US 2007/0196115 A1
(43) Pub. Date: Aug. 23, 2007

(54) IMAGE FORMING DEVICE

(75) Inventor: Kiyonori Soutome, Ibaraki (JP)

Correspondence Address: PATENTTM.US, P. O. BOX 82788, PORTLAND, OR, 97282-0788, US

(73) Assignee: CANON FINETECH INC., Ibaraki (JP)

(21) Appl. No.: 11/668,076

(22) Filed: Jan. 29, 2007

(30) Foreign Application Priority Data
Jan. 31, 2006 (JP) 2006-23883

(51) Int. Cl. G03G 15/00

(52) U.S. Cl. 399/16

(57) ABSTRACT

In the image forming device, a discrepancy in timing of a control sequence is corrected, which is caused by abrasion of a paper sheet detection member placed on a paper sheet transport path from a paper feeder to a transfer part, the paper sheet detection member contacting the paper sheet to detect a paper sheet. A registration sensor functioning as the paper sheet detection member is placed on the paper sheet transport path from the paper feeder to the transfer part, and it contacts the paper sheet to detect a paper sheet. In transporting the paper sheet, time T′ from when the paper sheet detection member detects the trailing edge of the paper sheet until when the trailing edge of the paper sheet passes through the transfer nip part is measured, and a difference ΔT between the time T′ being measured and a predetermined reference time T is obtained. According to this difference, timing values T01, T02, and T03 of the timing control sequence are corrected, which are determined based on a registration sensor OFF signal.

### DETAILED DESCRIPTION

1. Field of the invention

The present invention relates to an image forming device such as a printer, a copying machine, and a facsimile machine, in which an imaging process mechanism employing a recording method such as an electrophotographic image forming method, an electrostatic recording method, and a magnetic recording method, forms and supports an unfixed image corresponding to target image information on a paper sheet, introduces the paper sheet into a fixing unit to thermally fix the unfixed image on the paper sheet, and outputs an image recorded object.

2. Related Art

In a conventional image forming device, there is provided a sensor for detecting a paper sheet, between a paper feeder that feeds the paper sheet from a paper cassette and a transfer part that transfers a toner image formed on a photoconductive drum onto the paper sheet, the sensor being referred to as a “registration sensor”. A paper sheet is fed from the paper cassette and the leading edge of the paper pushes down the registration sensor. This triggers outputting of a registration sensor ON signal. This registration sensor ON signal is used as a base point to determine a timing of turning ON high voltages used in a control sequence required for image forming. When the trailing edge of the paper sheet has passed through the registration sensor and the registration sensor returns to the initial position, this triggers outputting of a registration sensor OFF signal. This registration sensor OFF timing is used as a base point to determine a timing of turning OFF the high voltages used in the control sequence required for the image forming. A mechanical switch, so called “flag”, is used as the registration sensor, having a stick-like member that is constantly pressed in such a manner as projecting outwardly by a weak spring force, and this stick-like member is pushed in against the spring force when the paper sheet moving through a transport path contacts the registration sensor.

Japanese Unexamined Patent Application Publication No. 63-183474 and Japanese Unexamined Patent Application Publication No. 5-11635 each suggests a technique that detects whether or not a paper sheet exists between a transfer roller and an image bearing member, on the basis of a change in a energizing state of the transfer roller to be energized. By the use of the technique above, the present applicant proposes a technique that measures a time necessary for the paper sheet from the leading edge to the trailing edge to pass through the transfer part, obtains a paper sheet transport speed, and controls the change of the paper sheet transport speed to be adjusted to a target speed (see Japanese Unexamined Patent Application Publication No. 2006-276700).

In the case of the registration sensor utilizing such a mechanical switch as described above, the switch comes into contact with and slides on the paper sheet every time when the paper sheet is transported, so as to detect the leading and trailing edges of the paper sheet. Consequently, when the accumulated number of sheets of the paper having passed becomes large, a tip of the registration sensor may be abraded or worn. As for the leading edge of the paper sheet being transported, it firstly contacts a root of the registration sensor. Therefore, even though the tip of the registration sensor is worn, a relationship between the registration sensor ON timing and the paper sheet leading edge is not changed before and after occurrence of the abrasion of the registration sensor. However, as for the relationship between the registration sensor OFF timing and the trailing edge of the paper sheet, the angle formed by pressing down the registration sensor in the registration sensor ON state becomes smaller if the tip of the registration sensor is worn, resulting in that the time required for returning to the OFF position from the registration sensor ON state becomes shorter. In other words, when the registration sensor is worn, the registration sensor OFF signal according to the trailing edge of the paper sheet is outputted earlier than the signal outputted from the sensor without any abrasion. Consequently, the timing of the control sequence required for forming an image also becomes earlier, because it is determined on the basis of this registration sensor OFF signal.

In order to overcome such a problem as described above, a material of the registration sensor is changed to be resistant to abrasion, or enough margins are set in the control sequence required for forming an image.

However, even if a material resistant to abrasion is used, it is not possible to completely prevent the abrasion, because it has to be brought into contact with the paper sheet. On the other hand, if sufficient margins are given in the state where the registration sensor is not worn, the control sequence on printing may unnecessarily continue even within “inter-paper sheet fog”, which is a time period between paper sheets successively transferred. Therefore, toner may adhere to a non-image part on the photoconductive drum, a drum memory due to a transfer voltage may be generated, and the drum life may be shorten due to elongation of time being electrically charged.

The photoconductive drum serving as an image bearing member, and the transfer roller on which a predetermined voltage is applied to transfer a toner image on the photoconductive drum to the paper sheet, constitute a transfer nip part on a contact point therebetween. In order to transport the paper sheet from the paper cassette to the transfer nip part, a feeding roller as a transport roller is employed. An additional transport roller may be prepared, if necessary. The surface of the feeding roller is worn down in proportion to the number of paper sheets passed therethrough, resulting in that the diameter of the feeding roller becomes smaller. Accordingly, a speed to transport the paper sheet by the transport roller may be lowered, even if the feeding roller is kept driven at the same rotation speed. As a result, if the timing of control sequence is determined by the time period between the points of time, i.e., registration sensor ON time and OFF time, the abrasion of the transport roller may cause a discrepancy between the control sequence and an actual position of the paper sheet.

Furthermore, the fixing unit, which thermally fixes a non-fixed toner image on the paper sheet, generally includes a fixing film being heated and a pressure roller that rotates while being brought into contact with the fixing film with pressure. The pressure roller is made of a heat-resistant material, but it may be expanded due to the heat generated in using the fixing unit. In general, even if a minimum sized paper sheet is used, the leading edge of the paper sheet enters the fixing nip part of the fixing unit before the trailing edge of the paper sheet exits from the transfer nip part. Therefore, if the pressure roller that receives a rotary driving force is expanded, the diameter thereof becomes larger, resulting in that a transport speed by the fixing unit for transporting the paper sheet becomes higher than a scheduled value. Accordingly, this may also substantially cause a delay in timing in the control sequence.

The present invention has been made considering the background as described above, and an object of the present invention is to provide an image forming device that is capable of correcting a discrepancy in timing of the control sequence, which is caused by abrasion of a paper sheet detection member that contacts and detects the paper sheet, the paper sheet detection member being placed on a path for transporting the paper sheet, continuing from the paper feeder to the transfer part.

Another object of the present invention is to provide an image forming device that is capable of correcting a problem caused by abrasion of the transport roller.

Further alternative object of the present invention is to provide an image forming device that is capable of correcting a problem caused by the expansion of the pressure roller of the fixing unit.

### SUMMARY OF THE INVENTION

An aspect of the present invention is directed to an image forming device that transfers a toner image formed on an image bearing member to a paper sheet being fed, including, a paper sheet detection member that contacts and detects the paper sheet placed on a paper sheet transport path from a paper feeder to a transfer part, a time measuring means that measures, when the paper sheet is transported, a time period from when the paper sheet detection member detects a trailing edge of the paper sheet until when the trailing edge of the paper sheet passes through a transfer nip part, a difference calculating means that obtains a difference between the time period being measured and a predetermined reference time period, and a timing correcting means that corrects a timing value of a control sequence according to the difference being obtained.

The timing of the control sequence to be corrected may be a timing that is determined on the basis of the detection of the OFF signal from the paper sheet detection member, for instance.

“The time period from when the paper sheet detection member detects the trailing edge of the paper sheet until when the trailing edge of the paper sheet passes through the transfer nip part” measured by the time measuring means may be varied depending on worn degree of the tip of the paper sheet detection member. Therefore, it is possible to assume the degree of abrasion, according to the difference obtained in the difference calculating means that compares the above time period with the predetermined reference time period. In addition, the degree of abrasion will appear as an error in timing of the control sequence. Therefore, by correcting the timing value of the control sequence according to the difference above, the discrepancy in timing of the control sequence due to the abrasion of the paper sheet detection member may be corrected.

A storing means may be provided to store the timing value of the control sequence, which has been corrected according to the difference. Therefore, if the difference stays unchanged hereafter, correction can be carried out by using this stored timing value without performing the time measurement again.

It is further possible to provide a storing means to store the difference and the difference value itself may be stored.

Another aspect of the present invention is directed to an image forming device that transfers a toner image formed on the image bearing member onto a paper sheet being fed, including a paper sheet detection member that contacts and detects the paper sheet placed on the paper sheet transport path from the paper feeder to the transfer part, a time measuring means that measures, when the paper sheet is transported, a time period from when the paper sheet detection member detects the leading edge of the paper sheet until when the leading edge of the paper sheet reaches a transfer nip part, a difference calculating means that obtains a difference between the time period being measured and a predetermined reference time period, and a transport speed correcting means that controls a transport speed so that an error in the transport speed of the paper sheet is corrected according to the difference.

Since a distance from the paper sheet detection member to the transfer nip part is fixed, “the time period from when the paper sheet detection member detects the leading edge of the paper sheet, when the paper sheet is transported, until when the leading edge of the paper sheet reaches the transfer nip part” is varied according to the transport speed at which the paper sheet is transported. The paper sheet transport speed is determined by a rotation speed of the transport roller that transports the paper sheet. However, even if the rotation speed is kept constant, the paper sheet transport speed is lowered when the transport roller is worn. Therefore, “the time period from when the paper sheet detection member detects the leading edge of the paper sheet, when the paper sheet is transported, until when the leading edge of the paper sheet reaches a transfer nip part” becomes longer in proportion to the worn degree of the transport roller. Therefore, by obtaining the difference between the time being measured and the predetermined reference time, it is possible to assume how much the transport roller is worn according to the size of the difference. Furthermore, by correcting the drive rotation speed of the transport roller according to this difference, an error in the paper sheet transport speed can be corrected.

It is possible to assume that the larger the difference between the time period being measured and the predetermined reference time period, the more the transport roller is worn. Therefore, the life of the transport roller can be determined based on this difference.

Another aspect of the present invention is directed to an image forming device that transfers a toner image formed on an image bearing member onto a paper sheet and fixes the toner image on the paper sheet by a fixing unit, including, a checking means that checks a length of the paper sheet in a transporting direction, a paper sheet detection member that contacts and detects the paper sheet placed on a paper sheet transport path from a paper feeder to a transfer part, a time measuring means that measures, when the paper sheet is transported, a time period from when a leading edge of the paper sheet passes through a transfer nip part, until when a trailing edge of the paper sheet passes through the transfer nip part, a difference calculating means that obtains a difference between the time period being measured and a reference transport time period determined according to the length of the paper sheet in the transporting direction, and a correcting means that corrects a timing value in a control sequence and/or a paper sheet transport speed, according to the difference.

The time period from when the leading edge of the paper sheet passes through the transfer nip part until when the trailing edge of the paper sheet passes through the transfer nip part is determined to be constant, according to the length of the paper sheet in the transporting direction. However, if the pressure roller of the fixing unit located downstream of the transfer nip part is expanded due to heat, the paper sheet transport speed may become higher, even if the rotation speed of the pressure roller is kept constant. Therefore, the time period from when the leading edge of the paper sheet passes through the transfer nip part until when the trailing edge of the paper sheet passes through the transfer nip part is varied depending on the degree of expansion of the pressure roller. Therefore, by obtaining a difference between the time period being measured and the predetermined reference time period, it is possible to assume how much the pressure roller is expanded, according to the size of the difference. By correcting a timing value of the control sequence according to this difference, it is possible to correct a problem that is caused by the expansion of the pressure roller.

According to an aspect of the present invention, a time period from when the trailing edge of the paper sheet exits from the paper sheet detection member until when it passes through the transfer nip part is measured, and a result of the measurement is compared to the predetermined reference time, thereby calculating a discrepancy in timing caused by the abrasion of the paper sheet detection member, and correcting the discrepancy in timing of the control sequence caused by the abrasion of the paper sheet detection member. Consequently, a problem that will be caused by the discrepancy in timing of the control sequence can be prevented. Specifically, it is not necessary to set margins in timing of the control sequence more than required. As a result, occurrence of problems can be prevented, such as inter-paper sheet fog, generation of drum memory due to a transfer voltage, and shortening of the life of the drum due to the elongation of electrically charged time.

Further, according to an aspect of the present invention, the time period from when the leading edge of the paper sheet exits from the paper sheet detection member until when it reaches the transfer nip part is measured, and this result of the measurement is compared with the predetermined reference time period. With this procedure, it is possible to calculate a discrepancy in timing caused by the abrasion of the paper sheet transport roller, and correct the discrepancy in timing of the control sequence caused by the abrasion of the paper sheet detection member. In addition, it is possible to determine the life of the transport roller. Consequently, problems caused by the discrepancy in timing of the control sequence as described above can be prevented.

According to an aspect of the present invention, the time period from when the leading edge of the paper sheet passes through the transfer nip part until when the trailing edge of the paper sheet passes through the transfer nip part is measured, and a result of the measurement is compared with the reference transport time that is determined by the length of the paper sheet -in the transporting direction. Then, according to the difference therebetween, the timing value of the control sequence and/or the paper sheet transport speed can be corrected. Consequently, it is possible to prevent the problems caused by the discrepancy in timing of the control sequence as described above.

### DESCRIPTION OF THE DRAWINGS

FIG. 1 illustrates a schematic internal configuration of an image forming device relating to an embodiment of the present invention;

FIG. 2(a) to FIG. 2(c) illustrate relationships between positions of a registration sensor, respectively when it is worn and when it is not worn, and the registration sensor ON/OFF signals;

FIG. 3(a) and FIG. 3(b) each illustrates an area from the registration sensor to the transfer nip part within the paper sheet transport path in the device shown in FIG. 1;

FIG. 4(a) and 4(b) are illustrations to compare the control sequences relating to image forming, being decided based on the conventional registration sensor OFF signal, respectively when the registration sensor is not worn and when the registration sensor is worn;

FIG. 5(a) and 5(b) are illustrations showing the control sequences respectively when the registration sensor is not worn and when the registration sensor has been worn, according to an embodiment of the present invention;

FIG. 6(a) illustrates a point of time before the paper sheet P reaches the transfer nip part, and FIG. 6(b) illustrates that the paper sheet P is in the course of passing through the transfer nip part;

FIG. 7 is a chart that illustrates a method for detecting the leading edge and the trailing edge of the paper sheet by a load for detecting a transfer current;

FIG. 8 is a flowchart that illustrates a control procedure according to an embodiment of the present invention;

FIG. 9(a) and FIG. 9(b) each illustrates, similar to FIG. 3(a) and FIG. 3(b), an area from the registration sensor to the transfer nip part in the paper sheet transport path in the device shown in FIG. 1;

FIG. 10(a) and 10(b) are illustrations showing the control sequences respectively when the transport roller is not worn and when the transport roller is worn, according to an embodiment of the present invention;

FIG. 11 is a flowchart that illustrates a control procedure according to a second embodiment of the present invention;

FIG. 12 is a flowchart that illustrates an example of processing for determining and displaying the life of the transport roller according to the second embodiment of the present invention;

FIG. 13(a) and FIG. 13(b) each illustrates an area from the transfer nip part Nt to the fixing unit in the paper sheet transport path of the device shown in FIG. 1;

FIG. 14(a) and 14(b) are illustrations showing the control sequences when the pressure roller is expanded and not expanded, according to a third embodiment of the present invention; and

FIG. 15 is a flowchart that illustrates a control procedure according to the third embodiment of the present invention.

### DETAILED DESCRIPTION

Hereinafter, preferred embodiments of the present invention will be explained in detail, with reference to the accompanying drawings.

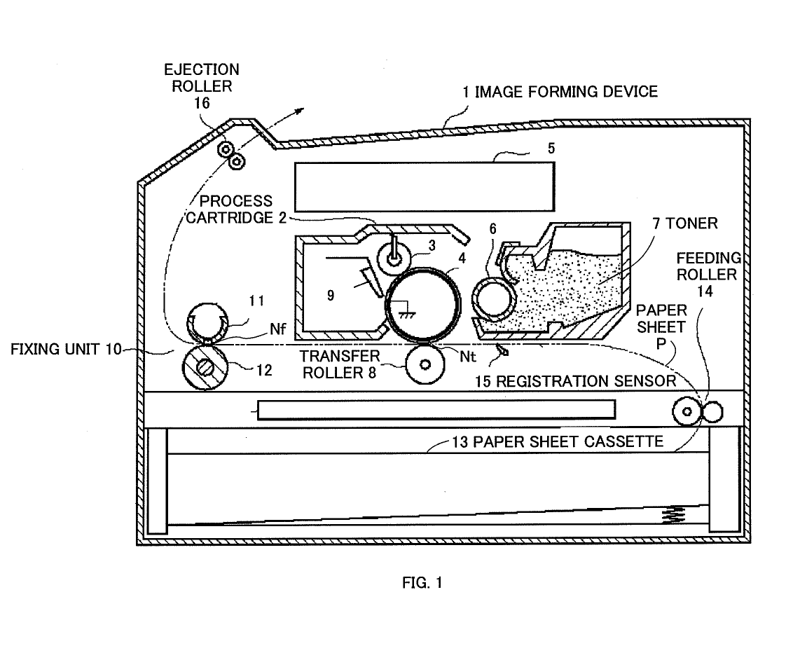

FIG. 1 illustrates a schematic internal configuration of the image forming device 1 relating to an embodiment of the present invention. In here, an explanation will be made taking a printer as an example, but the present invention is not limited thereto.

Inside the image forming device 1, a process cartridge 2 is detachably mounted, which incorporates units for forming an image. The process cartridge 2 includes a photoconductive drum (i.e. image bearing member) 4, a charging roller 3 that charges the surface of the photoconductive drum 4 uniformly, toner 7 as a developer, a developing sleeve 6 that uses the toner 7 to manifest a latent image on the photoconductive drum 4 being exposed, and a cleaning blade 9. A scanner part 5 modulates and scans a laser beam according to an image data being transmitted, and exposes the surface of the photoconductive drum 4.

In the image forming process, the photoconductive drum 4 is charged to a certain potential by the charging roller 3, and then, by the scanner part 5, a large number of points on the photoconductive drum 4 are exposed according to the image to be recorded, and the potential at the points is reduced to a predetermined level. Next, utilizing a difference between the potential having been lowered on the photoconductive drum 4, and the potential to be applied to the developing sleeve 6, in other words, utilizing an action in the electric field, charged toner 7 on the developing sleeve 6 is adhered onto the photoconductive drum 4. The toner 7 adhered to the photoconductive drum 4 is transported into a predetermined transfer area, and the transfer roller 8 serving as a transfer member, transfers the toner onto the paper sheet P, which has been transported by a feeding roller 14 from a paper cassette 13. Subsequently, the paper sheet P on which the toner image is placed is thermally fixed by the fixing film 11 and the pressure roller 12 of the fixing unit 10, and then ejected by the ejection roller 16. The toner 7 that adheres to the photoconductive drum 4 and failed in being transferred is scratched by the cleaning blade 9 and collected into a discarded toner receiving space within the process cartridge 2.

A registration sensor 15 functioning as a paper sheet detection member is placed on the paper sheet transport path from the feeding roller 14 that constitutes a paper feeder, up to the transfer roller 8 that constitutes a transfer part. As described above, the registration sensor 15 is a mechanical switch called as “flag”, which is constantly pushed outwardly with a weak spring force and pushed-in against the spring force when the paper sheet moving on the transport path contacts this registration sensor. This flag is usually made up of a stick-like member that is kept upright by the spring force, and upon passage of the paper sheet, it tilts by pivoting about a pivoting shaft. The registration sensor 15 has a role as the following: When the leading edge of the paper sheet P reaches the position of the registration sensor 15 and contacts the same to push it down, using this point of time as a base point, ON timing of high voltages and exposure is determined, relating to the start of an image forming. When the trailing edge of the paper sheet P has exited from the position of the registration sensor 15, the registration sensor 15 will rise and return to an original position. Using as a base point, the timing when the registration sensor 15 gets up, the OFF timing of the high voltages and exposure is determined, relating to the end of image forming. In the present embodiment, a control of high-voltages for the transfer roller during the printing is explained assuming that the control is operated under the condition that the voltage is kept constant.

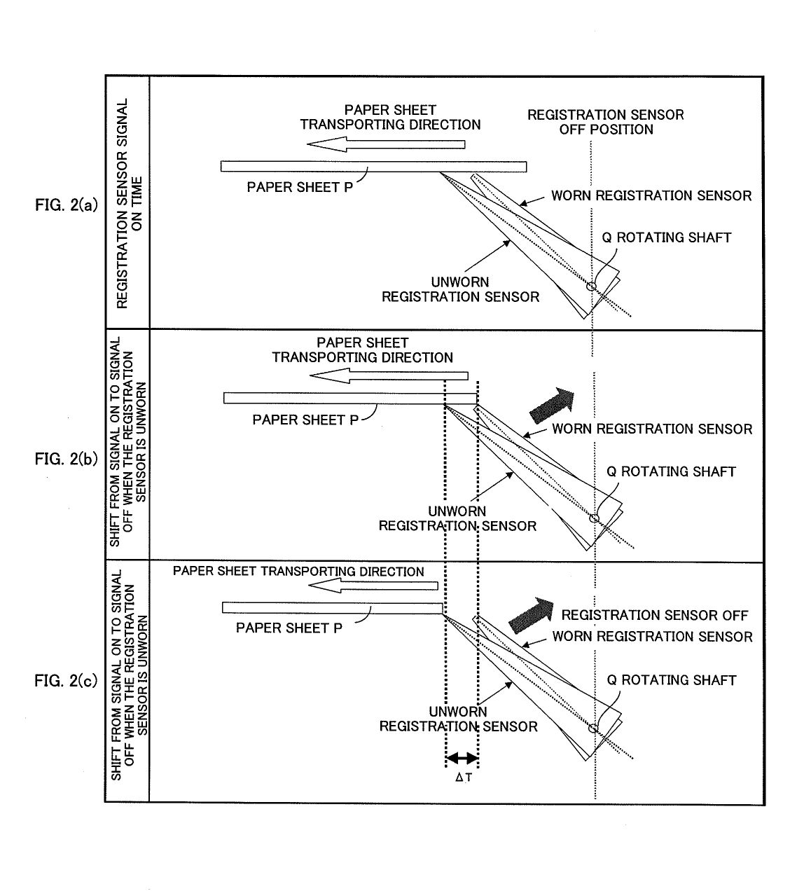

FIG. 2(a) to FIG. 2(c) illustrate relationships between positions of the registration sensor, respectively when it is worn and when it is not worn, and the registration sensor ON/OFF signals. In a default state where the registration sensor 15 is not influenced by the paper sheet P, the tip of the registration sensor 15 is facing vertical direction from the rotating shaft Q. When the tip of the paper sheet P contacts the registration sensor 15, the registration sensor 15 pivotally inclines about the rotating shaft Q, and the paper sheet P goes over the registration sensor as illustrated. When the registration sensor 15 pivotallly inclines from the registration sensor OFF position, a switch not illustrated is driven, and a registration sensor ON signal is outputted. At this registration sensor ON timing, the leading edge of the paper sheet P being transported contacts a portion lower than the tip of the registration sensor 15. Therefore, the registration sensor ON timing is always the same, regardless of whether the registration sensor 15 is worn or not. However, as shown in FIG. 2(a), while the registration sensor ON signal is outputted, the inclining angle is different depending on the situation whether or not the registration sensor 15 is worn. When the length of the registration sensor 15 is short due to the abrasion, the registration sensor ON state is kept at a position closer to the registration sensor OFF position than the situation without any abrasion. As a result, as shown in FIG. 2(b) and 2(c), a discrepancy in timing occurs when the trailing edge of the paper sheet P exits from the registration sensor 15, depending on the situation whether or not the registration sensor 15 is worn. In other words, a difference T occurs in the time period from when the paper sheet P has exits from the registration sensor 15 until when the registration sensor 15 returns to the registration sensor OFF position. This time difference may influence the OFF timing in the control sequence that uses the registration sensor OFF signal as a base point.

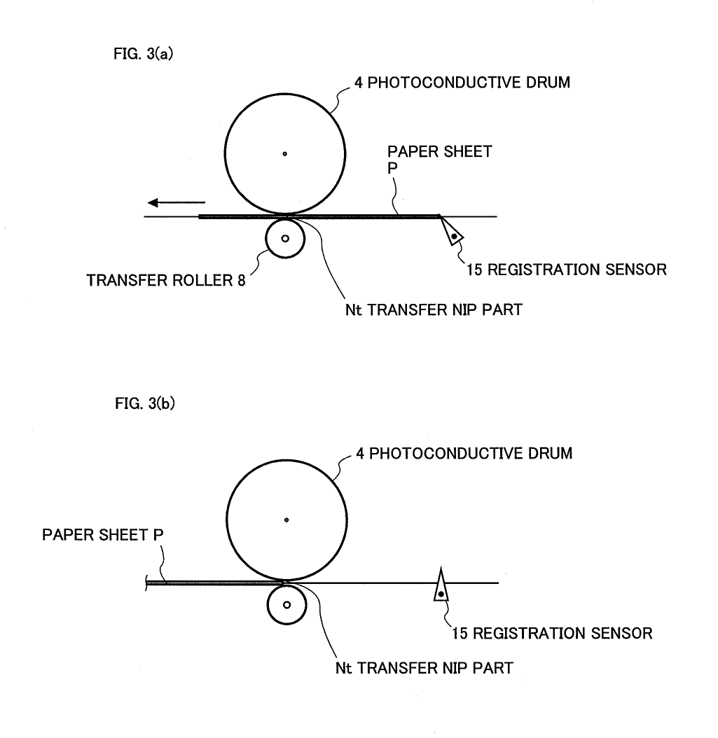

FIG. 3(a) and FIG. 3(b) each illustrates an area from the registration sensor to the transfer nip part within the paper sheet transport path in the device shown in FIG. 1. FIG. 3(a) illustrates a state where the trailing edge of the paper sheet P is in the point of passing through the registration sensor 15, and FIG. 3B illustrates a state where the trailing edge of the paper sheet P is in the point of passing through the transfer nip part Nt. The distance from the registration sensor 15 to the transfer nip part Nt is a fixed value depending on individual models of image forming device. In transporting the paper sheet, the time period from when the registration sensor 15 detects the trailing edge of the paper sheet, until when the trailing edge of the paper sheet passes through the transfer nip part Nt is varied depending on the worn degree of the registration sensor.

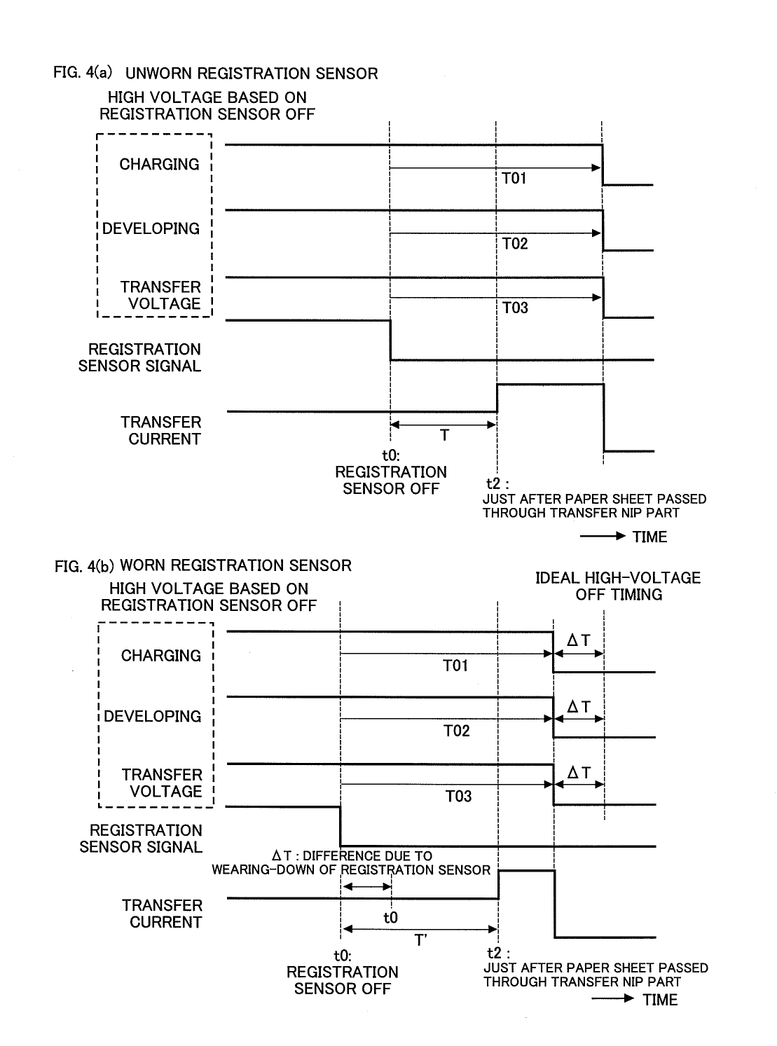

FIG. 4(a) and 4(b) are illustrations to explain high-voltage OFF timing, i.e. the timing of turning OFF high voltages used for the image forming, being decided based on the conventional registration OFF signal, respectively when the registration sensor is not worn and when the registration sensor is worn. Firstly, FIG. 4(a) shows a control sequence in the case where the registration sensor 15 is not worn in a conventional configuration. When the registration OFF signal is outputted at the point t0, the points of high-voltage OFF timing for charging, developing, and transferring are respectively set to the points after the lapse of time T01, T02, and T03 from the point t0. As shown in the following equation, the time T is equal to a difference between the point t2 when the trailing edge of the paper sheet P passes through and exits from the transfer nip part Nt, and the point t0 when the registration sensor OFF signal is outputted.
T=t2−t0

FIG. 4(b) illustrates a control sequence in the case where the registration sensor OFF signal is outputted at an earlier timing, due to the abrasion of the registration sensor 15. When the point of outputting the registration sensor OFF signal becomes the point t0′ that is earlier than t0, the difference between the point t2 when the trailing edge of the paper sheet P passes through and exits from the transfer nip part Nt, and the point t0′ is expressed as:
T′=t2−t0′
Here, t0>t0′ leads to T′>T. As for ΔT as a difference between T and T′, the following equation is established:
ΔT=T′−T=t0−t0′.

ΔT indicates a variation in time when the registration OFF signal is generated, which is caused by the abrasion of the registration sensor 15. Accordingly, if the registration sensor OFF signal is outputted earlier by ΔT due to the abrasion of the registration sensor 15, points of OFF timing of charging, developing, and transferring are set to be earlier than an ideal value by ΔT, because those points of OFF timing are determined by using the registration sensor OFF signal as a base point.

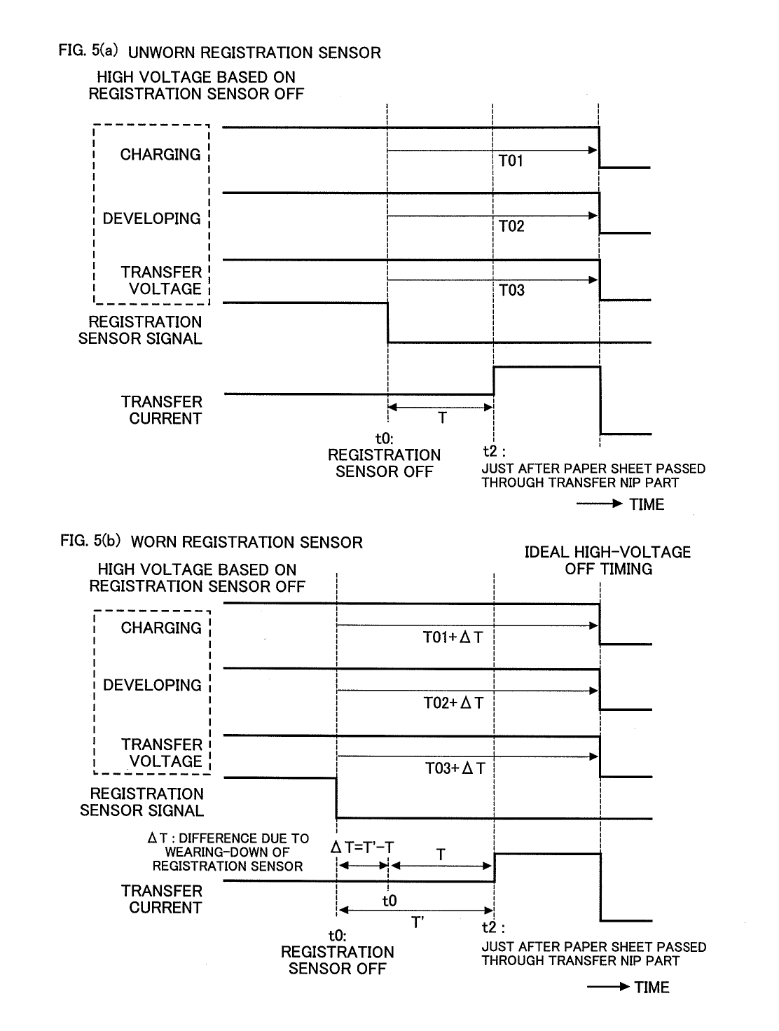

FIG. 5(a) is an illustration showing the control sequence when the registration sensor is not worn, according to an embodiment of the present invention. This timing is identical to the timing as shown in FIG. 4(a). On the other hand, FIG. 5(b) is an illustration showing the control sequence when the registration sensor has been worn, according to an embodiment of the present invention. When the registration sensor OFF signal is outputted earlier by ΔT as in the case of FIG. 4(b), points of the OFF timing of charging, developing, and transferring, which are determined by using the registration sensor OFF signal as a base point, are extended by ΔT. The extension by ΔT is actually used to the next printing after ΔT is calculated.

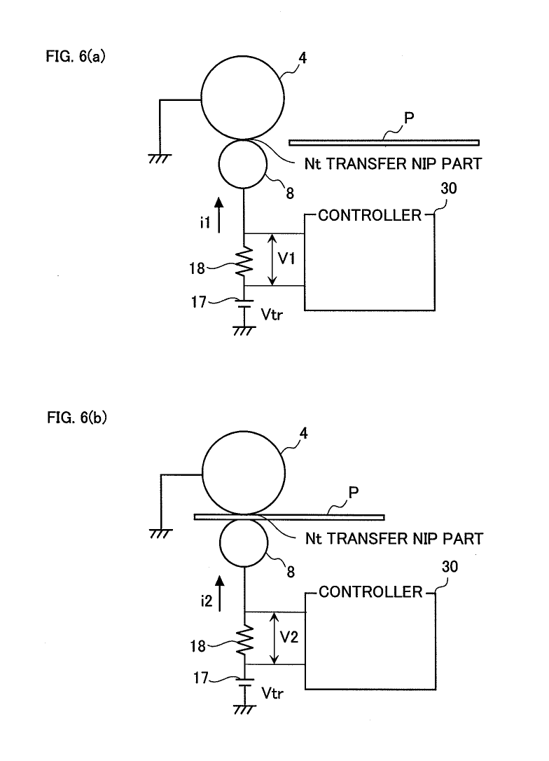

Next, a method for calculating T′ will be explained. T′ indicates a time period from a point t′0 being the output timing of the registration sensor OFF signal to a point of time t2 when the trailing edge of the recording paper P passes through and exits from the transfer nip part Nt, with respect to the transport speed Pv of the paper sheet P. FIG. 6(a) illustrates a point of time before the paper sheet P reaches the nip part (transfer nip part Nt) which is between the photoconductive drum 4 and the transfer roller 8. FIG. 6(b) illustrates that the paper sheet P is in the course of passing through the transfer nip part Nt. In FIG. 6(a) and FIG. 6(b), the transfer high-voltage power supply 17 applies a constant voltage Vtr to the transfer roller 8, and the backside of the paper sheet P is charged by current i1 that flows by applying the constant voltage. Then, using a potential difference between the photoconductive drum 4 and the backside potential on the paper sheet P, the toner 7 on the photoconductive drum 4 is transferred to a print surface of the paper sheet P. In the preferred embodiment, a transfer current detection load 18 is provided between the transfer high-voltage power supply 17 and the transfer roller 8. Here, resistance value R of this transfer current detection load 18 is set to be 10⁶ Ω by way of example. The resistance value R of the transfer roller 8 in the present embodiment is set to be around 10⁹ Ω. Comparing to this value, the value of 10⁶ Ω for the transfer current detection load is extremely small, and it does not exert any effect on the transfer process. As shown in FIG. 6(a), if “i1” is assumed as current that flows into the load 18 for the voltage Vtr outputted by the transfer high-voltage at the time when the paper sheet P has not reached the nip part of the transfer roller 8, voltage drop V1 at the transfer current detection load 18 is as the following:
V1=i1*R

This value is measured by the controller 30.

Similarly, as shown in FIG. 6(b), when the paper sheet P is in the course of passing through the nip part of the photoconductive drum 4 and the transfer roller 8, the voltage applied in the constant voltage control is Vtr. Since the paper sheet P exists at the nip part, the flowing current is lowered by the amount corresponding to the resistance value of the paper sheet P. If the current at this moment is assumed as i2 (i1>i2), then the voltage drop V2 at the transfer current detection load 18 is as the following:
V2=i2*R

By way of example, it is assumed that the resistance value R of the transfer current detection load 18 is set to 10⁶ Ω, the current i2 required for the transfer process is set to 3.5 μA, and applied voltage Vtr is set to Vtr=2.0 kV so as to output 3.5 μA with the present resistance value of the transfer roller 8. Under those conditions, the voltage drop of the transfer current detection load 18 is assumed as V1. On the other hand, the voltage drop of the transfer current detection load 18 is assumed as V2 in the case where the current i1=5.0 μA, when the paper sheet P does not exist at the nip part. V1 and V2 are expressed as the following:
(1) When the paper sheet P does not exist at the nip part
   V1=[5.0](μA) * 10⁶ (Ω)=[5.0](V)
(2) When the paper sheet P exists at the nip part
   V2=[3.5](μA) * 10⁶ (Ω)=[3.5](V)

Shifting from V1 to V2 occurs when the leading edge of the paper sheet P enters the nip part, and shifting from V2 to V1 occurs when the trailing edge of the paper sheet P exits from the nip part. By monitoring the voltage output changing at the transfer current detection load 18, it is possible to detect a point of time when the leading edge of the paper sheet P enters the nip part, and a point of time when the trailing edge of the paper sheet exits from the nip part. According to the time T between the both points of time and a length L of the paper sheet (the length in the transporting direction) based on the paper sheet size obtained by a user setting, it is possible to calculate a paper sheet transport speed Pv at a given time. In the present exemplary embodiment, the paper sheet transport speed Pv is assumed as constant.

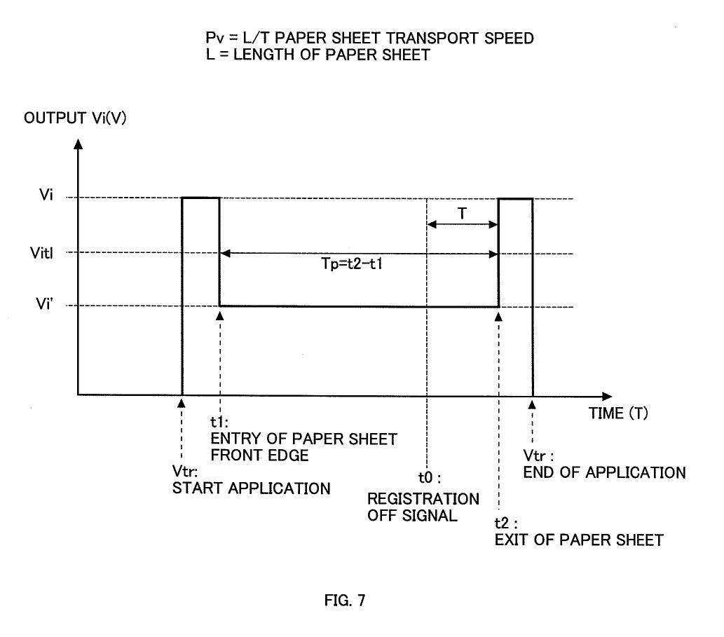

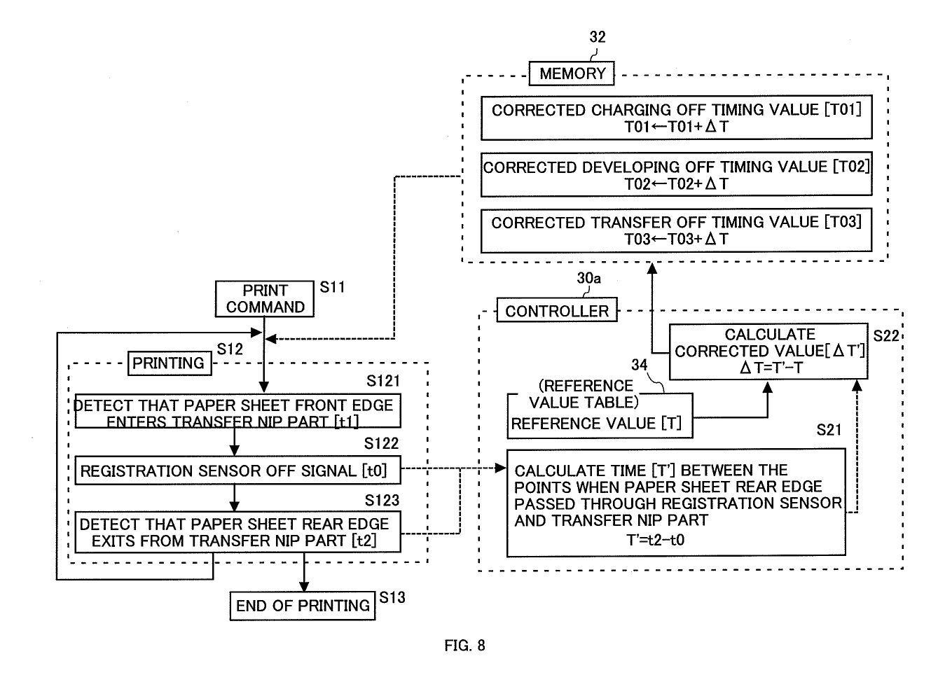

FIG. 7 is a chart that illustrates a method for detecting the leading edge and the trailing edge of the paper sheet by the transfer current detection load 18. Firstly, when the registration sensor 15 detects the leading edge of the paper sheet and outputs a registration ON signal, the transfer high-voltage Vtr is applied at a time when the paper sheet is upstream of the transfer nip part Nt. On this occasion, the voltage drop at the transfer current detection load 18 is V1. Next, when the leading edge of the paper sheet P enters the transfer nip part Nt at the point of time t1, the voltage drop at the transfer current detection load 18 becomes Vi′. In addition, when the trailing edge of the paper sheet P exits from the transfer nip part Nt at the point of time t2, the voltage drop at the transfer current detection load 18 becomes Vi. Threshold voltage Vit1 is set in advance, and timing t1 and timing t2 are detected. Here, the timing t1 indicates a time when the output voltage at the transfer current detection load 18 becomes equal to or lower than the threshold voltage Vit1 within the time period of applying the transfer voltage Vtr, and the timing t2 indicates a time when it becomes equal to or higher than the threshold voltage Vit1. Then, the timing t1 and the timing t2 are stored in the memory (reference numeral 32 in FIG. 8 described below) as a storage unit within the image forming device 1. Time period Tp required for the paper sheet P to pass through the transfer nip part Nt can be obtained by Tp=t2−t1. It is further possible to obtain the paper sheet transport speed Pv based on the time Tp and paper sheet length L.
Paper sheet transport speed: Pv=L/Tp

“T” is the time difference between the point of time t2 when the trailing edge of the paper sheet P exits from the transfer nip part Nt and the point of time t0 that is a registration sensor OFF time.

FIG. 8 is a flowchart that illustrates a control procedure according to an embodiment of the present invention. A program describing the procedure to execute a process in the flowchart is stored in a program storage unit (not illustrated) within the CPU, and the process is realized when the CPU interprets and executes the program. This procedure is applied to other flowcharts described in the following.

In the process as shown in FIG. 8, when the image forming device receives a print command (S11), a paper sheet P is fed from the paper cassette 13, and printing operation is started (S12). In this printing operation, firstly the registration sensor 15 detects the leading edge of the paper sheet and outputs a registration sensor ON signal, an elapsed time is monitored using the signal as a base point, and at a predetermined point of time, charging, developing, and application of transfer high-voltage Vtr are started. Subsequently, when the leading edge of the paper sheet reaches upstream of the transfer nip part Nt, monitoring of the voltage drop Vi at the transfer current detection load 18 is started. When it is detected that the voltage drops to Vi′, it is determined that the leading edge of the paper sheet has entered the transfer nip part Nt, and the point of time t1 is specified (S121). This point of time t1 is not particularly utilized in the current processing, but it is made available when the paper sheet transport speed is obtained as described above. The point of time t0 is detected, when the trailing edge of the paper sheet has passed through the registration sensor, and a registration sensor OFF signal is generated (S122). Thereafter, upon detecting that the voltage drop Vi′ has returned to Vi, it is determined that the trailing edge of the paper sheet has exited from the transfer nip part Nt, and this point of time t2 is specified (S123). If more than one paper sheet is printed, the above processing is repeated. Then, printing is ended (S13).

The controller 30a according to the present invention, which functions as a time measuring means, a difference calculating means, and a timing correcting means obtains time T′ from the points of time t2 and to (S21). Here, by using a reference value T and the time T′, a time difference ΔT between T and T′ is calculated (S22) Here, T is a reference value that is obtained from the reference value table 34 prepared in advance, under the condition that the paper sheet transport speed is Pv. Using this time difference ΔT as correction value, the charging OFF timing T01, developing OFF timing T02, and transfer OFF timing T03 are corrected and those corrected values are stored in the memory 32. The correction value is added and the corrected values are read out from the memory 32 at the time of next printing, so as to be used to control the timing. It is further possible to store the time difference ΔT itself in the memory 32, and according to this value, the charging OFF timing T01, developing OFF timing T2, and transfer OFF timing are corrected, every time when the correction is necessary. It is to be noted that the process to calculate the corrected values may be performed at any point of time, such as every time a print command is received, when the power of the device is turned on, and when a user issues a direction.

Next, a second embodiment of the present invention will be explained.

A schematic internal configuration of the image forming device according to the present embodiment is the same as shown in FIG. 1, and tedious explanations will not be made. The second embodiment is directed to a correction of a defect caused by the abrasion of the transport roller.

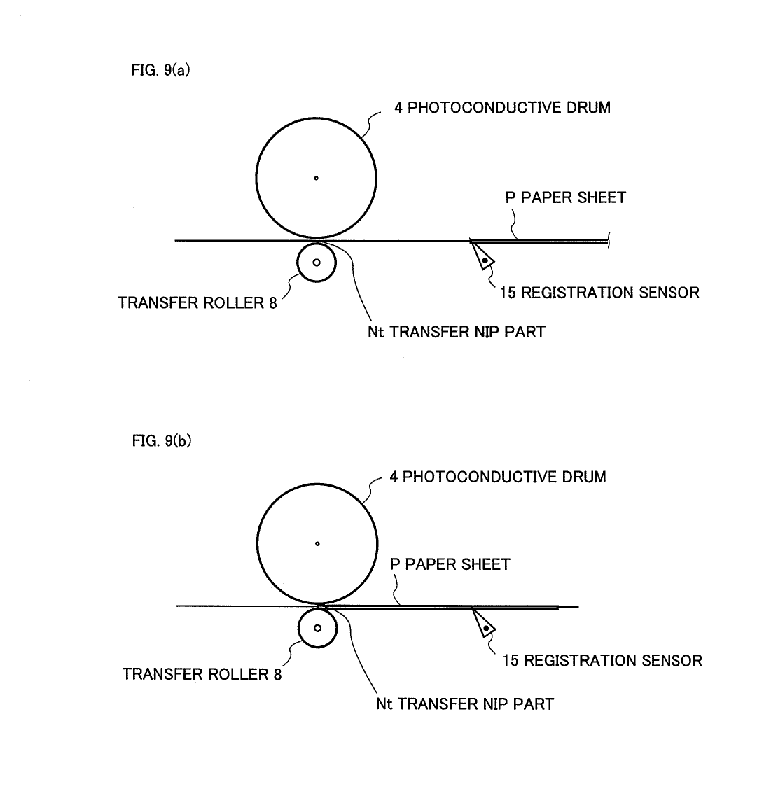

FIG. 9(a) and FIG. 9(b) each illustrates, similar to FIG. 3(a) and FIG. 3(b), an area from the registration sensor to the transfer nip part in the paper sheet transport path in the device shown in FIG. 1. FIG. 9(a) illustrates a point of time when the leading edge of the paper sheet P has reached the registration sensor 15, and FIG. 9(b) illustrates a point of time when the leading edge of the paper sheet P has reached the transfer nip part Nt. As described above, the distance from the registration sensor 15 to the transfer nip part Nt is a fixed value depending on individual models of image forming device. Therefore, “the time period from when the registration sensor 15 detects the leading edge of the paper sheet until when the leading edge of the paper sheet reaches the transfer nip part Nt” is varied depending on the transport speed of the paper sheet. The paper sheet transport speed is determined by the rotating speed of the transport roller that transports the paper sheet. Even though the rotating speed of the transport roller is kept constant, the paper sheet transport speed may be lowered if the transport roller is worn. Therefore, “the time period from when the paper sheet detection member detects the leading edge of the paper sheet until when the leading edge of the paper sheet reaches the transfer nip part Nt” becomes longer in proportion to the worn degree of the transport roller.

In view of the fact above, the present inventor have conceived that by measuring the time period and calculating a difference between the measured time and a predetermined reference time, it is possible to assume how much the transport roller is worn, according to the size of the difference. The present inventor have further conceived that by correcting the drive rotating speed of the transport roller based on the difference above, it is possible to correct the paper sheet transport speed, that is, correct the error in the transport speed.

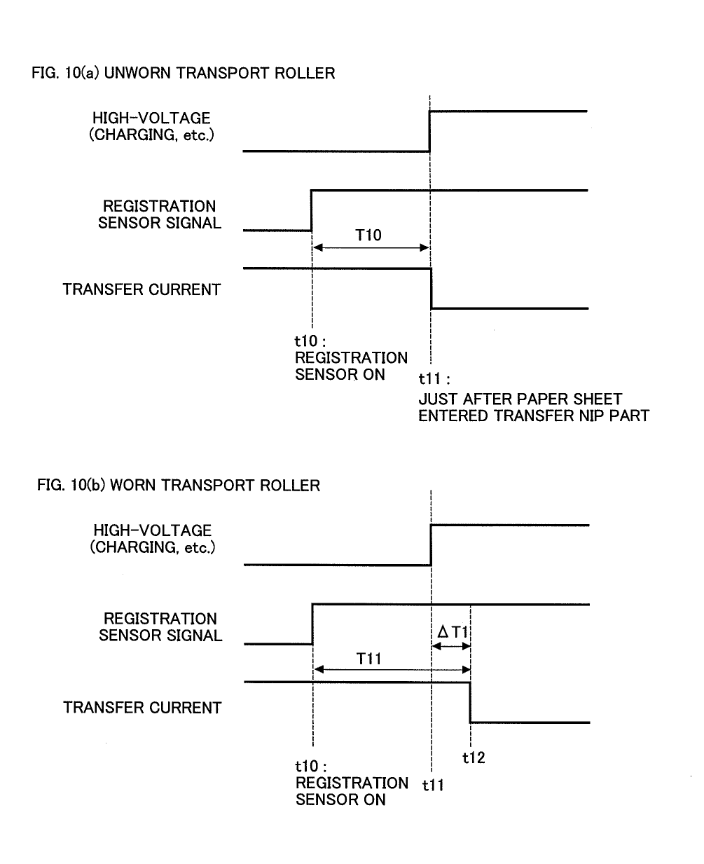

FIG. 10(a) and 10(b) are illustrations showing the ON timing of high voltages, respectively when the transport roller is not worn and when the transport roller is worn, according to an embodiment of the present invention. As shown in FIG. 10(a), when the transport roller is not worn and there is no other factor to vary the paper sheet transport speed, the high-voltage ON time is scheduled to start at a point of time when the time T10 has elapsed from the registration sensor ON time. On the other hand, as shown in FIG. 10(b), as the abrasion of the transport roller proceeds, the diameter of the transport roller becomes smaller, thereby lowering the paper sheet transport speed. Therefore, the time T11 until the leading edge of the paper sheet reaches the transfer nip part Nt becomes longer than T10 by ΔT. Consequently, high-voltage is turned ON before the paper sheet reaches the transfer nip part Nt.

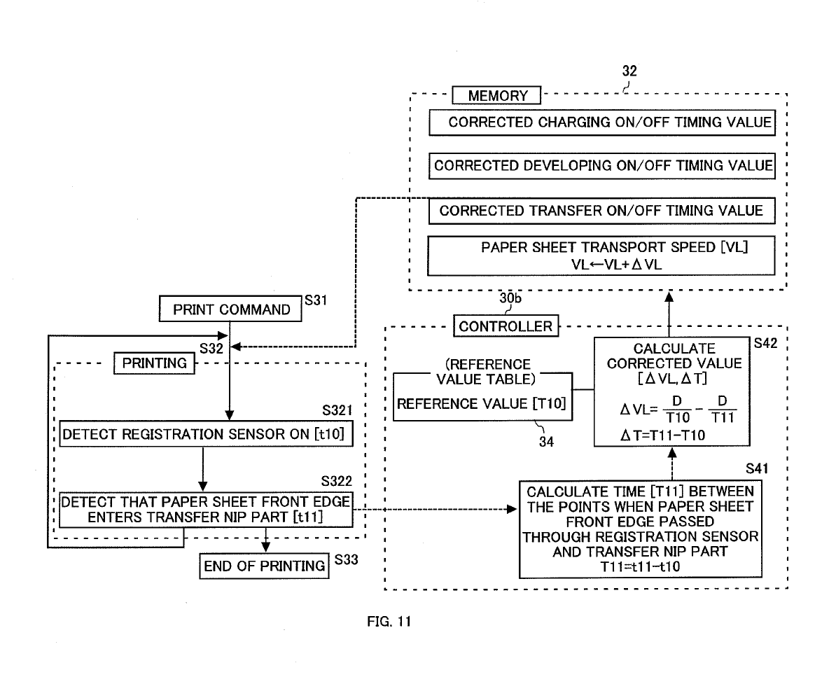

FIG. 11 is a flowchart that illustrates a control procedure according to the second embodiment of the present invention.

In the process as shown in FIG. 11, when the image forming device receives a print command (S31), a paper sheet P is fed from the paper cassette 13, and printing operation is started (S32). In the printing operation, firstly the registration sensor 15 detects the leading edge of the paper sheet and outputs a registration sensor ON signal (S321). This point of time is assumed as “t10”. Using this ON signal as a base point, an elapsed time is monitored, and at a predetermined point of time, charging, developing, and application of transfer high-voltage Vtr are started. When the leading edge of the paper sheet reaches upstream of the transfer nip part Nt, monitoring of the voltage drop Vi at the transfer current detection load 18 is started. When it is detected that the voltage drops to Vi′, it is determined that the leading edge of the paper sheet enters the transfer nip part Nt, and the point of time t11 is specified (S322). If more than one paper sheet are printed, the above processing is repeated. Then, printing is ended (S33).

The controller 30b, which functions as a time measuring means, a difference calculating means, and a timing correcting means, calculates time T11 that is a difference between the points of time t12 and t10 (S41) Here, by using the reference value T10 obtained from the prepared reference value table 34 and the time T11, an error in the paper sheet transport speed ΔVL is calculated by the following equation (S422):
ΔVL=(D/T10)−(D/L11)

Here, “D” indicates a distance from the registration sensor 15 to the transfer nip part Nt.

A value obtained by adding ΔVL to the original VL is stored in the memory 32, as the speed value having been corrected by the above speed error ΔVL, and this corrected VL is used to control the paper sheet transport speed in the next printing.

“The time period from when the paper sheet detection member detects the leading edge of the paper sheet until when the leading edge of the paper sheet reaches the transfer nip part Nt” as explained by FIG. 10(a) and FIG. 10(b) is longer in proportion to the worn degree of the transport roller. Therefore, by measuring the time period and calculating a difference between the measured time and a predetermined reference time, it is possible to assume how much the transport roller is worn according to the size of the difference.

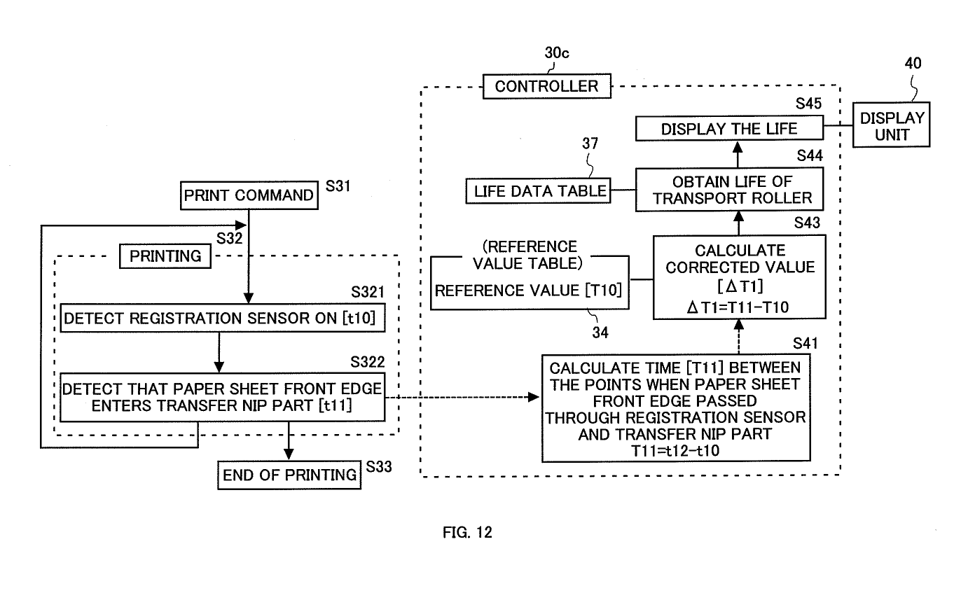

FIG. 12 illustrates an example of processing for determining and displaying the life of the transport roller. The same constituents shown in FIG. 11 are labeled the same, and tedious explanations will not be made.

The processing up to step S41 is the same as shown in FIG. 11. Thereafter, the controller 30c that functions as a time measuring means and a life determining means calculates a time ΔT1 as a difference between the time T11 and the time T10 in step S42. With reference to the life data table 37 that stores in advance ΔT1 values and life values indicating the life of the transport roller, in such a manner as associated with each other, a life value of the transport roller associated with the time ΔT1 calculated in step S43 is obtained (S44). The life value may be a numeric value representing the life, and alternatively, it may be a class name that classifies the life according to rank. An example of the class name may be, A: No problem, B: Be ready for transport roller change, and C: Change of transport roller is necessary, and in step S45, the obtained life information is displayed on the display unit 40 in step S45.

It is to be noted that the displaying of the life in FIG. 12 and the control of the paper sheet speed in FIG. 11 may be employed simultaneously.

Next, a third embodiment of the present invention will be explained.

A schematic internal configuration of the image forming device according to the present embodiment is as shown in FIG. 1, and tedious explanations will not be made. The third embodiment is directed to a correction of a defect caused by expansion of the pressure roller of the fixing unit.

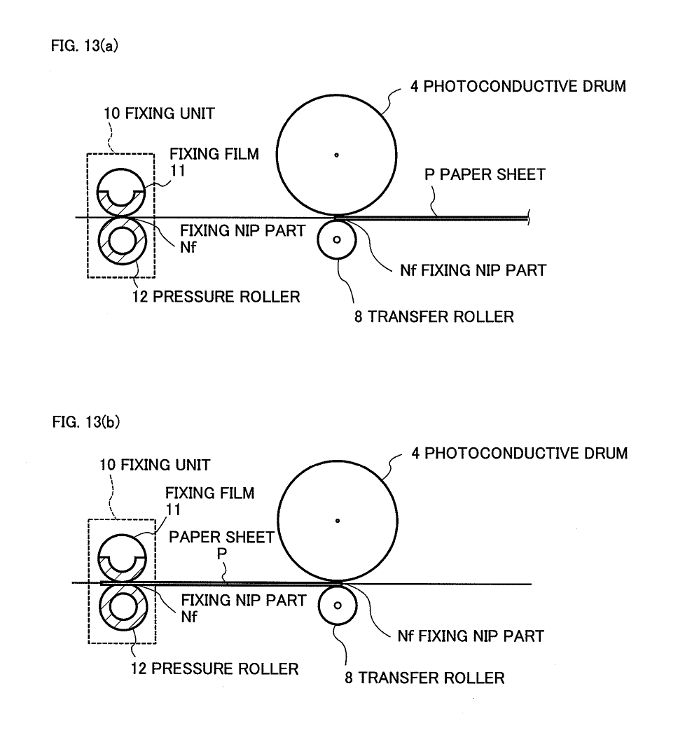

FIG. 13(a) and FIG. 13(b) each illustrates an area from the transfer nip part Nt to the fixing unit in the paper sheet transport path of the device as shown in FIG. 1. FIG. 13(a) illustrates a state of the paper sheet P when the leading edge of the paper sheet P reaches the transfer nip part Nt, and FIG. 13(b) illustrates a state of the paper sheet P when the trailing edge of the paper sheet P exits from the transfer nip part Nt.

As described above, the fixing unit, which thermally fixes an non-fixed toner image on the paper sheet, generally includes a fixing film (or a fixing roller) 11 being heated and a pressure roller that rotates while being brought into contact with the fixing film (or the roller) with pressure. The pressure roller is made of a heat-resistant material, but it may be expanded due to the heat being generated. In general, even when a minimum sized paper sheet is used, the leading edge of the paper sheet may enter the fixing nip part Nf of the fixing unit before the trailing edge of the paper sheet exits from the transfer nip part Nt. Therefore, if the pressure roller that receives a rotary driving force is expanded, the diameter thereof becomes larger, resulting in that a paper sheet transport speed by the fixing unit 10 becomes larger than a scheduled speed. Accordingly, this may also cause a delay in timing in the control sequence, substantially.

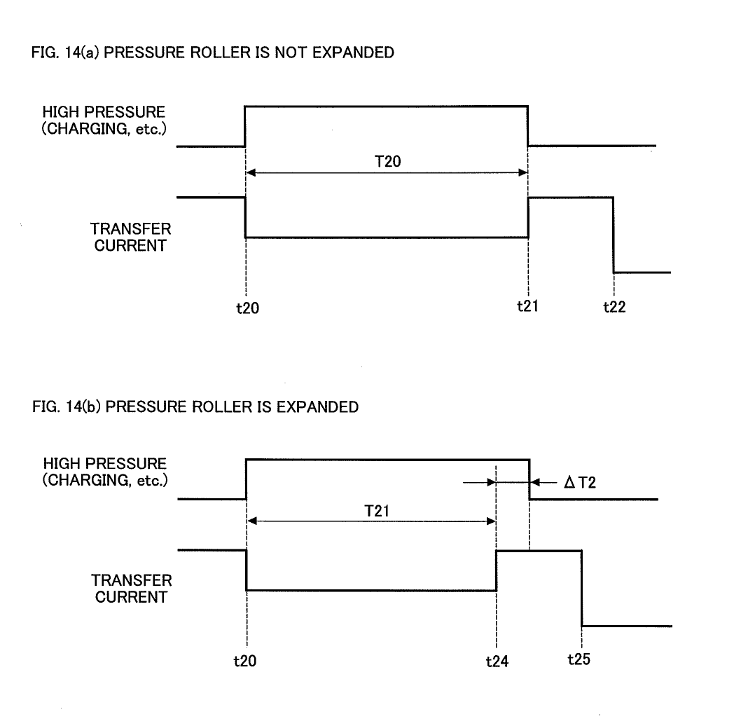

As shown in FIG. 14(a) and FIG. 14(b), if there is no expansion of the pressure roller, the time period T20 from when the leading edge of the paper sheet passes through the transfer nip part Nt until when the trailing edge of the paper sheet passes through the transfer nip part Nt, when the paper sheet is transported, is determined by the paper sheet length L in the transporting direction and a predetermined paper sheet transport speed. After the leading edge of the paper sheet reaches the fixing nip part Nf, the paper sheet transport speed is made higher by the expansion of the pressure roller 12. Then, the time period T21 from when the leading edge of the paper sheet passed through the transfer nip part Nt until when the trailing edge of the paper sheet passes through the transfer nip part Nt is shorted by ΔT2 from the time period T20. By using the error time ΔT2, the OFF timing of the high voltages is corrected.

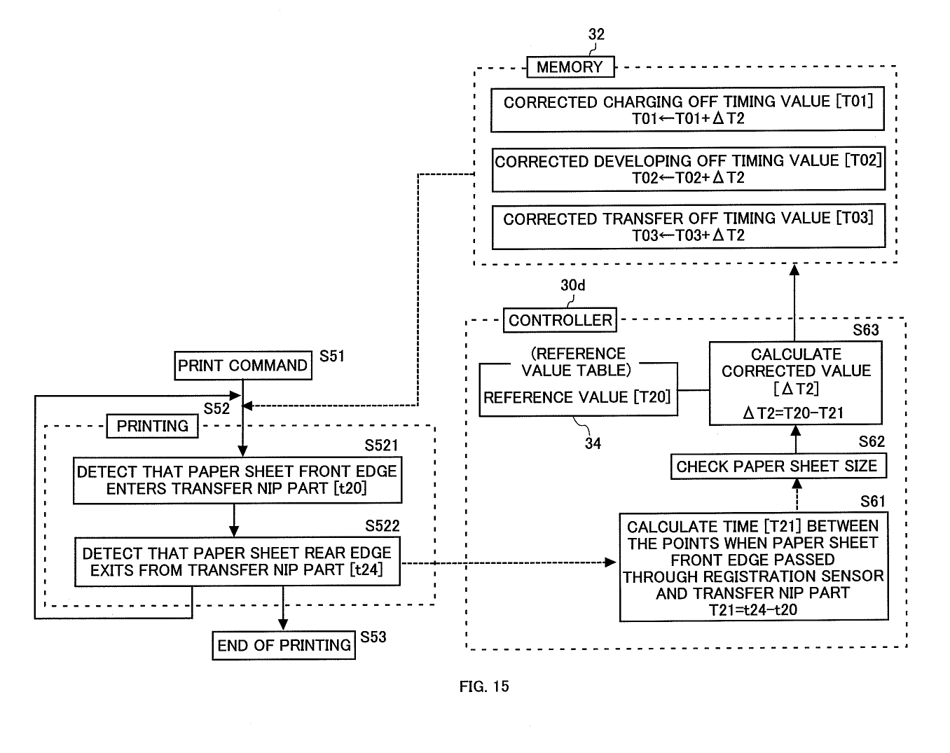

FIG. 15 is a flowchart that illustrates a control procedure according to the third embodiment of the present invention.

In the process as shown in FIG. 15, when the image forming device receives a print command (S51), a paper sheet P is fed from the paper cassette 13, and printing operation is started (S52). In the printing operation, firstly a point of time t20 is detected when the leading edge of the paper sheet enters the transfer nip part Nt (S521). Subsequently, the point of time t24 is detected when the trailing edge of the paper sheet exits from the transfer nip part Nt (S522). If more than one paper sheet are printed, the above processing is repeated. Then, the print process is ended (S53).

The controller 30d which functions as a time measuring means, a difference calculating means, and a timing correcting means obtains a time period as a difference between the points of time t24 and t20, that is, a time period T21 required for the paper sheet to pass the transfer nip part Nt (S61). In addition, the size of the paper sheet (in particular, the length L in the transporting direction) is checked (S62). This length L can be obtained according to the dimension of the paper sheet, if it has a standard size. With reference to the reference value table 34 that stores in advance the paper sheet size (in particular, the length L in the transporting direction) and the time T20 required for passing through the transfer nip part Nt in such a manner as associated with each other, a reference value associated with the length L (i.e., reference transport time) T20 is obtained. Then, by the use of T20 and the time period T21, an error in time ΔT2=T20−T21 is obtained (S63). Then, the high-voltage OFF timing value having been corrected with the error time ΔT2 is stored within the memory 32, and this stored value is used when the high-voltage OFF timing is decided in printing the next page, when multiple pages are printed successively.

It is to be noted that expansion of the pressure roller is prone to occur when successive printing is carried out relatively within a short period of time, compared to the case where the flag is worn or the transfer roller is worn. Furthermore, even if the pressure roller is once expanded, it is returned to the original non-expanded state after a while. Therefore, after the end of the operation to print multiple pages successively, the high-voltage OFF timing value is reset to the original value.

While preferred embodiments of the present invention have been explained above, various modifications and changes are available in addition to the examples mentioned above. For instance, a constant voltage control is employed for controlling the transfer high-voltage in printing, but alternatively, a constant current control may be employed. In this case, it is possible to detect whether or not the paper sheet is in the course of passing through the transfer nip part Nt, according to a change in voltage.

In the present embodiment, the point of time when the paper sheet enters the transfer nip part Nt is determined by comparing a detected voltage and a predetermined threshold voltage. However, it may also be determined by comparing the gradient of the detected voltage (a differential value) and a predetermined reference value.

1. An image forming device that transfers a toner image formed on an image bearing member to a paper sheet being fed, comprising:
a paper sheet detection member that contacts and detects the paper sheet placed on a paper sheet transport path from a paper feeder to a transfer part;
a time measuring means that measures, when the paper sheet is transported, a time period from when the paper sheet detection member detects a trailing edge of the paper sheet until when the trailing edge of the paper sheet passes through a transfer nip part;
a difference calculating means that obtains a difference between the time period being measured and a predetermined reference time period; and
a timing correcting means that corrects a value of timing of a control sequence according to the difference being obtained.

2. The image forming device according to claim 1, wherein,
the timing of the control sequence to be corrected is determined on the basis of the detection of the OFF signal from the paper sheet detection member.

3. An image forming device that transfers a toner image formed on an image bearing member onto a paper sheet being fed, comprising:
a paper sheet detection member that contacts and detects the paper sheet placed on a paper sheet transport path from the paper feeder to the transfer part;
a time measuring means that measures, when the paper sheet is transported, a time period from when the paper sheet detection member detects the leading edge of the paper sheet until when the leading edge of the paper sheet reaches a transfer nip part;
a difference calculating means that obtains a difference between the time period being measured and a predetermined reference time period; and
a transport speed correcting means that controls a transport speed so that the paper sheet transport speed is corrected according to the difference.

4. The image forming device according to claim 3, wherein,
the paper sheet transport speed to be corrected is determined on the basis of a detection ON signal from the paper sheet detection member.

5. The image forming device according to claim 3, comprising:
a transport roller being placed on the paper sheet transport path from the paper feeder to the transfer part to transport the paper sheet, and
a life determining means that determines a life of the transport roller according to the difference.

6. An image forming device that transfers a toner image formed on an image bearing member onto a paper sheet being fed, comprising:
a transport roller placed on a paper sheet transport path from a paper feeder to a transfer part to transport the paper sheet;
a paper sheet detection member that contacts and detects the paper sheet placed on the paper sheet transport path from the paper feeder to the transfer part;
a time measuring means that measures, when the paper sheet is transported, a time period from when the paper sheet detection member detects the leading edge of the paper sheet until when the leading edge of the paper sheet reaches a transfer nip part;
a difference calculating means that obtains a difference between the time period being measured and a predetermined reference time period; and
a life determining means that determines a life of the transport roller according to the difference.

7. An image forming device that transfers a toner image formed on an image bearing member onto a paper sheet and fixing the toner image on the paper sheet by a fixing unit, comprising:
a checking means that checks a length of the paper sheet in a transporting direction;
a time measuring means that measures, when the paper sheet is transported, a time period from when a leading edge of the paper sheet passes through a transfer nip part, until when a trailing edge of the paper sheet passes through the transfer nip part;
a difference calculating means that obtains a difference between the time period being measured and a reference transport time period determined according to the length of the paper sheet in the transporting direction; and
a correcting means that corrects a timing value in a control sequence and/or a paper sheet transport speed, according to the difference.

8. The image forming device according to any one of claims 1, 3, 6 and 7, wherein,
the paper sheet detection member comprises a stick-like member that tilts by pivoting about a pivoting shaft, when the paper sheet passes therethrough.

9. The image forming device according to either of claim 1 and claim 7, further comprising:
a storing means that stores a corrected timing value of the control sequence, the value having been corrected according to the difference.

10. The image forming device according to any one of claims 1, 3, 6 and 7, further comprising:
a storing means that stores a value of the difference.

11. The image forming device according to claim 9, wherein,
the corrected value stored in the storing means is used in printing subsequent to a printing process when the difference is obtained.

12. The image forming device according to any one of claims 1, 3, 6 and 7, further comprising:
a transfer member to which a transfer voltage is applied so as to transfer a toner image formed on an image bearing member onto a print sheet being fed, wherein,
a point of time when the paper sheet passes through the transfer nip part is detected according to a change in current or voltage flowing in the transfer member.

13. The image forming device according to claim 12, wherein,
the change in current or voltage is determined by comparing the current or the voltage with a predetermined threshold.

14. The image forming device according to claim 12, wherein,
the change in current or voltage is determined by comparing a differential value of the current or the voltage with a predetermined threshold.
